(19) United States
(12) Patent Application Publication
(10) Pub. No.: US 2016/0132189 A1
(43) Pub. Date: May 12, 2016

(54) METHOD OF CONTROLLING THE DISPLAY OF IMAGES AND ELECTRONIC DEVICE ADAPTED TO THE SAME

(71) Applicant: Samsung Electronics Co., Ltd., Suwon-si (KR)

(72) Inventors: Jongchul CHOI, Suwon-si (KR); Changryong HEO, Suwon-si (KR); Yongsang YUN, Osan-si (KR); Jungeun LEE, Suwon-si (KR); Chihyun CHO, Suwon-si (KR)

(21) Appl. No.: 14/934,673

(22) Filed: Nov. 6, 2015

(30) Foreign Application Priority Data
Nov. 11, 2014 (KR) 10-2014-0156149

(51) Int. Cl. G06F 3/0481; G06F 3/01; G06F 3/16; G02B 27/01; G06F 3/0488; G06F 3/0484; G06T 3/40; G06T 19/00; G06F 3/0489

(52) U.S. Cl. CPC G06F 3/0481; G06T 19/006; G06F 3/012; G06F 3/013; G06F 3/167; G06F 3/017; G06F 3/0489; G06F 3/04883; G06F 3/04842; G06T 3/40; G02B 27/017; G06F 2203/04803; G06F 2203/04806

(57) ABSTRACT

A method of controlling a display of images and an electronic device adapted to the method are provided. The electronic device includes a display configured to display images, an input unit configured to detect an image display control input, and a controller configured to output a first image to the display, and control an auxiliary window to be displayed on a part of the first image, wherein the auxiliary window outputs a second image that has information about coordinates that differ from those of the first image.

### CROSS-REFERENCE TO RELATED APPLICATION(S)

This application claims the benefit under 35 U.S.C. §119(a) of Korean patent application filed on Nov. 11, 2014 in the Korean Intellectual Property Office and assigned Serial number 10-2014-0156149, the entire disclosure of which is hereby incorporated by reference.

### TECHNICAL FIELD

The present disclosure relates to a method of controlling a display of images in an electronic device, and the electronic device adapted to the method.

### BACKGROUND

Currently, wearable electronic devices that can be worn on the body of users have been developed. Wearable electronic devices may be implemented in various forms so that they can be detachably worn on a part of the body or clothing, e.g., a head-mounted display, smart glasses, a smart watch or wristband, contact lens-type devices, ring-type devices, shoe-type devices, clothing-type devices, glove-type devices, and the like.

Wearable electronic devices have attracted attention because they are worn on the body of the users and can provide services that have not been provided to users according to the related art. More particularly, technologies have been developed to implement virtual reality or augmented reality through wearable electronic devices to provide various user experiences.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method and an apparatus for controlling a display of images output to a display by using spatial display data.

Another aspect of the present disclosure is to provide a method and an apparatus for providing an auxiliary window onto a main image in a virtual reality or augmented reality environment and controlling a display of the main image through the auxiliary window.

In accordance with an aspect of the present disclosure, a method of controlling a display of images in an electronic device is provided. The method includes outputting a first image, and displaying an auxiliary window on a part of the first image in response to an auxiliary window request input, wherein the auxiliary window outputs a second image that has information about coordinates that differ from those of the first image.

In accordance with another aspect of the present disclosure, an electronic device is provided. The electronic device includes a display configured to display images, an input unit configured to detect an image display control input, and a controller configured to output a first image to the display, and control an auxiliary window to be displayed on a part of the first image, wherein the auxiliary window outputs a second image that has information about coordinates that differ from those of the first image.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description in conjunction with the accompanying drawings, in which:

FIG. 1 illustrates a block diagram of a head-mounted type (HMT) device according to various embodiments of the present disclosure;

FIG. 2 illustrates a block diagram of an electronic device according to various embodiments of the present disclosure;

FIG. 3 illustrates a perspective view of an electronic device coupled to an HMT frame according to various embodiments of the present disclosure;

FIG. 4 illustrates an exploded perspective view of an HMT frame and an electronic device, which are coupled to each other, according to various embodiments of the present disclosure;

FIG. 5 illustrates an HMT device being worn on a head of a user according to various embodiments of the present disclosure;

FIGS. 6A and 6B illustrate diagrams that describe an image display mode of an HMT device according to various embodiments of the present disclosure;

FIGS. 7A and 7B illustrate diagrams that describe an image display mode of an HMT device according to various embodiments of the present disclosure;

FIG. 8A illustrates a diagram that describes spatial display data provided by an HMT device according to various embodiments of the present disclosure;

FIG. 8B illustrates a diagram that describes spatial display data provided by an HMT device according to various embodiments of the present disclosure;

FIG. 8C illustrates a diagram that describes spatial display data provided by an HMT device according to various embodiments of the present disclosure;

FIGS. 9A, 9B, and 9C illustrate diagrams that describe an alteration of viewpoints of a user wearing an HMT device according to various embodiments of the present disclosure;

FIG. 10 illustrates a flow diagram that describes a method of controlling a display of images in an HMT device according to a first embodiment of the present disclosure;

FIGS. 11A, 11B, 11C, and 11D illustrate screens for controlling a display of images according to the first embodiment of the present disclosure;

FIG. 12 illustrates a flow diagram that describes a method of controlling a display of images in an HMT device according to a second embodiment of the present disclosure;

FIGS. 13A, 13B, and 13C illustrate screens for controlling a display of images according to the second embodiment of the present disclosure;

FIGS. 14A and 14B illustrate diagrams that describe a method of controlling a display of images in multi-directions according to various embodiments of the present disclosure;

FIG. 15 illustrates a flow diagram that describes a method of controlling a display of images in an HMT device according to a third embodiment of the present disclosure;

FIGS. 16A and 16B illustrate screens for controlling a display of images according to the third embodiment of the present disclosure;

FIGS. 16C and 16D illustrate screens for controlling a display of images according to the third embodiment of the present disclosure;

FIG. 17 illustrates a flow diagram that describes a method of inputting image control inputs according to various embodiments of the present disclosure; and

FIGS. 18A, 18B, 18C, 18D, and 18E illustrate diagrams of user inputs for controlling a display of images according to various embodiments of the present disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms or words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Hereinafter, a method of controlling a display of images and an electronic device adapted to the method, according to various embodiments of the present disclosure, are described. The electronic device, according to various embodiments of the present disclosure, may be a head-mounted type (HMT) device, but not limited thereto. The electronic device, according to various embodiments of the present disclosure, may be applied to all types of devices that can express display data including information about coordinates related to a location of an electronic device or a space output through the electronic device.

In an embodiment of the present disclosure, an HMT device may be a device, contacted or worn on both of the user's eyes, for displaying videos. The HMT device may provide a see-through function for providing augmented reality (AR) and/or a see-closed function for providing virtual reality (VR). The see-through function may mean a function that transfers real videos from the outside to the user's eyes through the display and also provides added information or an image as one video, in real-time, simultaneously. The see-closed function may mean a function that provides only content through videos on the display.

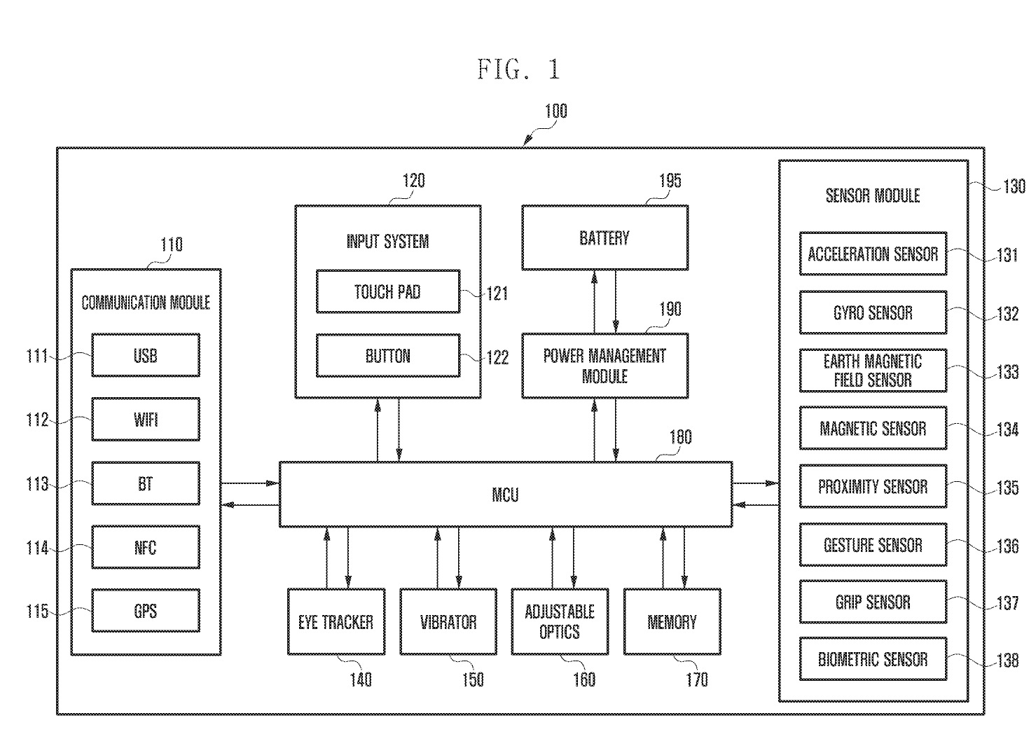

FIG. 1 illustrates a block diagram of a head-mounted type (HMT) device according to various embodiments of the present disclosure.

Referring to FIG. 1, an HMT device 100 may include a communication module 110, an input system 120, a sensor module 130, an eye tracker 140, a vibrator 150, an adjustable optics 160, a memory 170, a micro-controller unit (MCU) 180, a power management module 190, and a battery 195. Although it is not shown, it should be understood that the HMT device 100 may also include other components, e.g., a display, and the like.

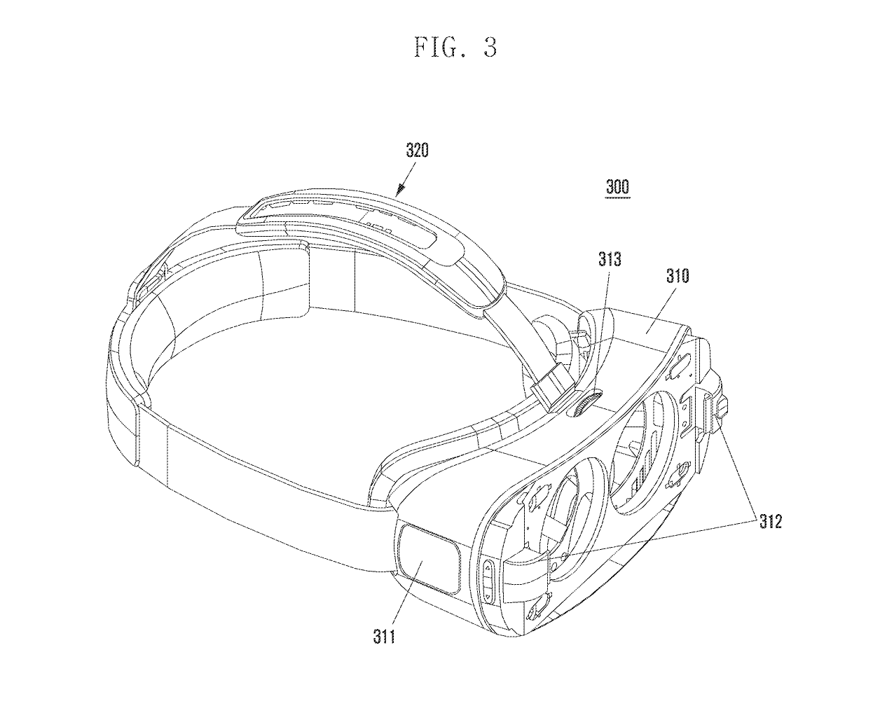

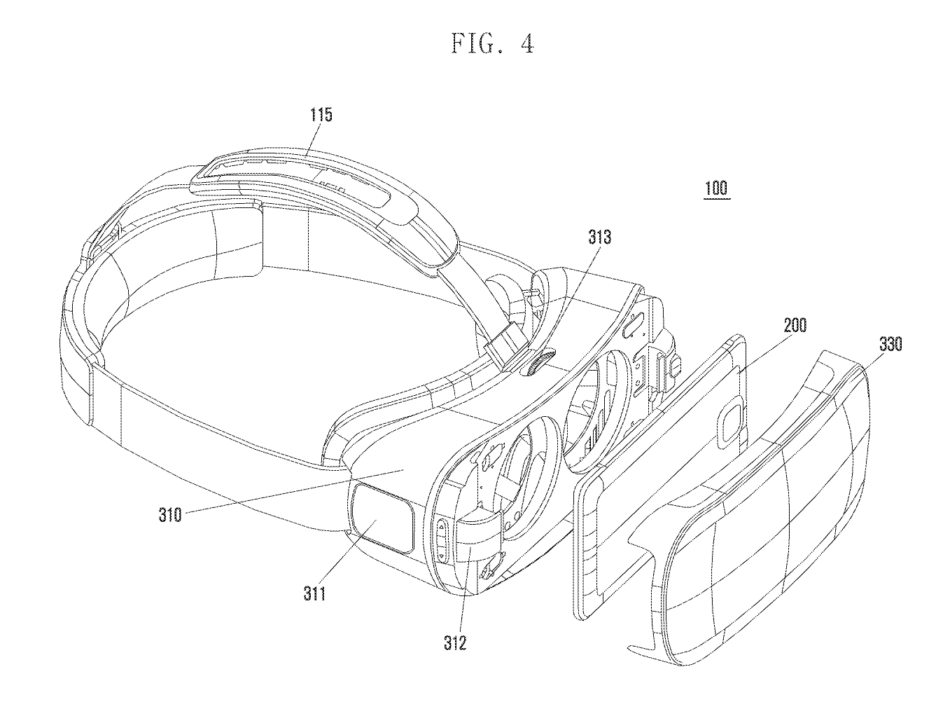

The HMT device 100, according to various embodiments of the present disclosure, may be designed so that it is coupled to external devices, or electronic devices, such as displays, smart phones, and the like. In this case, the HMT device 100 may be modified in such a way that parts of the components shown in FIG. 1 are included in the external device and the other parts are included in the HMT frame to be worn on the user's head. The frame of the HMT device 100, or HMT frame, will be described below referring to FIGS. 3 to 4.

The communication module 110 is connected to an external device to transmit/receive data thereto/therefrom, through wired/wireless communication. The communication module 110 may include at least one of a universal serial bus (USB) module 111, a wireless fidelity (WiFi) module 112, a Bluetooth (BT) module 113, a near field communication (NFC) module 114, and a global positioning system (GPS) module 115. For example, the communication module 110 may be designed so that part of at least two of the WiFi module 112, the BT module 113, the NFC module 114, and the GPS module 115, are included in one integrated chip (IC) or one IC package.

In an embodiment of the present disclosure, the communication module 110 may connect between the HMT frame and an external device to perform transmission/reception of data, through wired/wireless communication. For example, the communication module 110 may communicate with an external device through the USB module 111 as a communication interface. The USB module 111 is designed to be coupled with external devices.

The input system 120 may create signals related to control of the functions of the HMT device 100, and transfer the signals to the MCU 180. The input system 120 may include a touch pad 121 and buttons 122. The touch pad 121 may recognize touch inputs in at least one of capacitance detection, resistance detection, infrared detection, and ultrasonic wave detection. The touch pad 121 may include a control circuit. When the touch pad 121 is implemented in a capacitive type, the touch pad 121 may recognize proximity of an object as well as a physical contact or a touch. The touch pad 121 may further include a tactile layer. In this case, the touch pad 121 may offer tactile feedback to a user. The buttons 122 may include at least one of physical keys, physical buttons, optical keys, touch keys, joysticks, a wheel key, a keypad, and the like.

The sensor module 130 may detect operation states inside and outside the HMT device 100 to transfer information about the detected states to the MCU 180. The sensor module 130 may include at least one of, for example, an acceleration sensor 131, a gyro sensor 132, an earth magnetic field sensor 133, a magnetic sensor 134, a proximity sensor 135, a gesture sensor 136, a grip sensor 137, and a biometric sensor 138. The sensor module 130 may detect the movement of the user's head wearing the HMT device 100 through the acceleration sensor 131, gyro sensor 132, and earth magnetic field sensor 133. The sensor module 130 may detect at least one of a variation in IR detection amount, a variation in pressure detection amount, a variation in capacitance (permittivity), and the like, to determine whether the HMT device 100 is being worn by the user. The gesture sensor 136 may detect the movement of the user's hand or finger(s) to detect inputs for controlling the HMT device 100.

Additionally or alternatively, the sensor module 130 may recognize a user's biometric information through a biometric recognition sensor, such as, for example, an e-nose sensor, an electromyography (EMG) sensor, an electroencephalogram (EEG) sensor, an electrocardiogram (ECG) sensor, an iris scanner, and the like. The sensor module 1340 may further include a control circuit for controlling one or more sensors included therein.

The eye tracker 140 may measure the point of gaze of a user wearing the HMT device 100 through at least one of, for example, an electrooculography (EOG) sensor, coil systems, dual Purkinje systems, bright pupil systems, and dark pupil systems. The eye tracker 140 may further include a micro-camera (not shown) for measuring the eye positions (eye movement, point of gaze). For example, the eye tracker 140 may obtain an image of a user wearing the HMT device 100 through the camera, and extract a feature point from the obtained image to recognize the area of the user's eyes. The eye tracker 140 may recognize the eye movement through the area of the user's eyes to measure the point of gaze.

The vibrator 150 may convert an electrical signal to mechanical vibrations.

The adjustable optics (lens assembly) 160 may measure the user's inter-pupil distance (IPD) to allow the user to adjust the distance between the lenses so that he/she can watch videos at the correct resolution. The adjustable optics 160 may adjust, when designed in a form to be coupled with an external device, the position of the external device according to the user's IPD.

The memory 170 may store data or commands created from the MCU 180, the communication module 110, the input system 120, and the sensor module 130. The memory 170 may include program modules, such as kernel, middleware, application programming interface (API), and applications.

The memory 170 may include an internal memory and an external memory. The internal memory may include, for example, at least one of a volatile memory (e.g., a DRAM (Dynamic RAM), an SRAM (Static RAM), an SDRAM (Synchronous DRAM), and the like) or a nonvolatile memory (e.g., an OTPROM (One Time Programmable ROM), PROM (Programmable ROM), an EPROM (Erasable and Programmable ROM), an EEPROM (Electrically Erasable and Programmable ROM), a mask ROM, a flash ROM, a NAND flash memory, a NOR flash memory, and the like).

According to an embodiment of the present disclosure, the internal memory may have the form of a solid state drive (SSD). The external memory may include a flash drive, e.g., a compact flash (CF) drive, a secure digital (SD) drive, a micro-SD drive, a mini-SD drive, an eXtreme digital (xD) drive, a memory stick, and the like. The external memory may be functionally connected to the HMT device 100 through various interfaces. According to an embodiment of the present disclosure, the HMT device 100 may further include storage devices (or storage media), such as hard drives.

The MCU 180 may process display data according to the characteristics of the HMT device 100 to output the processed data to an external device or the display. The MCU 180 may include, for example, a processor. The MCU 180 may operate the operating system (OS) or the embedded software (S/W) to control a plurality of hardware components.

The MCU 180 may process spatial display data according to the display mode of the HMT device 100. The spatial display data may include information about coordinates and/or sequence information. The spatial display data may refer to a set of display data created and stored as the coordinate information items and the sequence information items are associated with each other. The information about coordinates may include location coordinates representing locations where the user or the electronic device is located in the virtual or real space, vector coordinates, or spatial coordinates of two- or three-dimensions for a spatial image displayed via the electronic device. For example, the spatial display data may be data (e.g., street view data, and the like) that is sequentially arrayed as location coordinates may vary, along with the user's viewpoint, in a process where the user moves toward a particular direction from a specific location, data representing virtual space, three dimensional (3D) spatial data, and the like.

The MCU 180 may alter an image to be displayed on the main screen and output the image thereto, according to at least one of the movement of a user's head wearing the HMT device 100, the user's point of gaze, a touch input, a voice input, a motion input, a key input, and the like. The MCU 180 may output an auxiliary window for defining part of the main screen in response to the user's input control. The area of the auxiliary window may share part of the image shown on the main screen.

The MCU 180 may process a user's inputs to output, to the auxiliary window area, an image with information about coordinates (e.g., location coordinates or spatial coordinates) that differs from the image displayed on the main screen, from among the spatial display data. The MCU 180 may alter the size, shape and location of the auxiliary window and output the altered result, according to a pre-defined setup value, a user's input, and a user's inter-pupil distance (IPD).

The power management module 190 may manage the electric power supplied to the HMT device 100. Although not shown, the power management module 190 may include, for example, a power management integrated circuit (PMIC), a charger IC, or a battery or fuel gauge. The PMIC may be formed, for example, of an IC chip or a system on chip (SoC). Charging may be performed in a wired or wireless manner. The charger IC may charge a battery 296 and prevent overvoltage or overcurrent from a charger. According to an embodiment of the present disclosure, the charger IC may have a charger IC used for at least one of wired and wireless charging types. A wireless charging type may include, for example, a magnetic resonance type, a magnetic induction type, or an electromagnetic type. Any additional circuit for a wireless charging may be further used, such as a coil loop, a resonance circuit, a rectifier, and the like.

The battery 195 may store or generate electricity, and may supply electric power to the HMT device 100 by using the stored or generated electricity. The battery 195 may include, for example, a rechargeable battery or a solar battery.

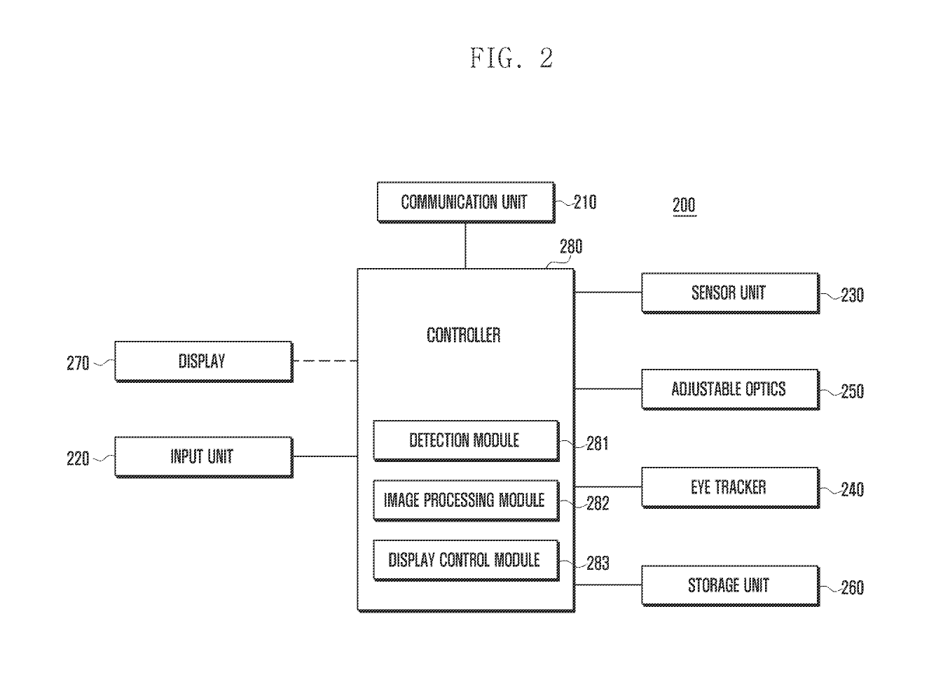

FIG. 2 illustrates a block diagram of an electronic device according to various embodiments of the present disclosure.

Referring to FIG. 2, an electronic device 200 may include a communication unit 210, an input unit 220, a sensor unit 230, an eye tracker 240, an adjustable optics 250, a storage unit 260, a display 270, and a controller 280.

The communication unit 210 may be connected to a network through wired/wireless communication or may perform voice communication, video communication or data communication with an external device, through inter-device communication, under the control of the controller 280. The communication unit 210 may include a radio frequency (RF) transmitter for up-converting the frequency of signals to be transmitted and amplifying power of the signals and a RF receiver for low-noise amplifying received signals and down-converting the frequency of the received signals. The communication unit 210 may also be equipped with the functions of the communication module 110 shown in FIG. 1.

The input unit 220 may create key signals for a user's settings and key signals related to the control of functions of the electronic device 200 to transfer the key signals to the controller 280. The input unit 220 may include at least one of a touch panel, a pen sensor, keys, and the like, to receive numerical or letter information and to set various functions. The touch panel may recognize a user's touch inputs in at least one of a capacitance detection mode, a resistance detection mode, an infrared detection mode, and an ultrasonic wave detection mode. The touch panel may further include a touch panel controller (not shown). When the touch panel is implemented in a capacitive type, the touch panel may recognize proximity of an object as well as a direct touch. The pen sensor may be implemented with a separate sheet for recognizing pen inputs in the same way as a user's touch inputs. The input unit 220 may be equipped with the functions of the input system 120 shown in FIG. 1.

The sensor unit 230 may detect operation states inside and outside the electronic device 200 to transfer information related to the detected states to the controller 280. The sensor unit 230 may be equipped with the functions of the sensor module 130 shown in FIG. 1.

The eye tracker 240 may measure the point of gaze of a user of the electronic device 200. The eye tracker 240 may further include a micro-camera (not shown) for measuring the eye positions (i.e., an eye movement, a point of gaze, and the like). The eye tracker 240 may be equipped with the functions of the eye tracker 140 shown in FIG. 1. The adjustable optics (or lens assembly) 250 may measure the user's inter-pupil distance (IPD) to allow the user to adjust the distance between the lenses and the position of the display 270 so that he/she can watch videos at the correct resolution. The adjustable optics 250 may be equipped with the functions of the adjustable optics 160 shown in FIG. 1.

The storage unit 260 may store data or commands transferred from or created by the controller 280 or the other components. For example, the storage unit 260 may store an OS for booting or controlling the electronic device 200 and the components described above, at least one application program, messages transmitted/received to/from a network, data related to the execution of applications, and the like. The storage unit 260 may be equipped with the functions of the memory 170 shown in FIG. 1.

The display 270 may display videos or data on the screen. The display 270 may include a display panel. The display panel may be implemented with a liquid crystal display (LCD), active matrix organic light emitting diodes (AM-OLEDs), and the like. The display 270 may be coupled with a touch panel to form a single module (e.g., a touch screen).

The controller 280 may decode commands for executing functions of the components in the electronic device 200, and perform operations or data processing according to the decoded commands. For example, the controller 280 may operate the OS or embedded software to control a plurality of hardware components. The controller 280 may include at least one processor.

The controller 280 may include a detection module 281, an image processing module 282, and a display control module 283.

The detection module 281 may detect a user's input for requesting the display of an auxiliary window on a main screen (or main area) corresponding to the size of the display 270, and a user's input for controlling the auxiliary window (e.g., movement, selection of the auxiliary window, and the like). The user's input may be at least one of a voice input, a touch input, a motion input, a gesture input, a detected result input, a brain wave input, a key input, and the like.

For example, the detection module 281 may detect a hand motion or gesture input from a video obtained through a camera (not shown). For example, the detection module 281 may separate an area corresponding to the hand from the image obtained from the activated camera by using color information, except for the background. The detection module 281 may extract feature points from the area corresponding to the hand to calculate the form (profile) of the hand. The detection module 281 may recognize the shape and motion of the hand by using information about the form of the hand. The detection module 281 may perform a pattern matching process based on the shape or motion of the hand, detect the hand motion or gesture input, and determine the command for controlling the auxiliary window according to the detection.

As another example, the detection module 281 may detect an input for requesting the display or control of the auxiliary window, through a separate input system or an input key installed to the electronic device 200. The detection module 281 may recognize the movement of a user's head through sensor information to detect a user's input according to the recognized user's head movement.

The image processing module 282 may process spatial display data according to a display mode of the electronic device 200.

The image processing module 282 may perform a process to output, to an auxiliary window area, an image that has information about coordinates (e.g., location coordinates or spatial coordinates) that differ from those of an image displayed on the main screen, from among spatial display data, according to a user's control inputs. For example, the image processing module 282 may determine a portion of an image matching an area on which the auxiliary window is displayed, from the spatial display data. The image processing module 282 may process data so that portion of an image matching the area of the auxiliary window can be displayed on the main screen in the form of picture-in-picture (PIP).

The display control module 283 may control the display 270 to display an image on the main screen according to a user's input control. The display control module 283 may alter an image to be displayed on the main screen in response to at least one of the movement of the user's head wearing the HMT device 100, the user's point of gaze, a touch, a voice input, a motion input, a key input, and the like, and output the altered image to the main screen. The display control module 283 may output an auxiliary window for defining part of the main screen in response to the user's input control. The area of the auxiliary window may share part of the image shown on the main screen.

The display control module 283 may alter the size, shape or location of the auxiliary window and output the altered result, according to a pre-defined setup value, a user's input, and a user's inter-pupil distance (IPD).

The display control module 283 may output, to the auxiliary window area, part of an image that has information about coordinates (e.g., location coordinates or spatial coordinates) that differ from those of a main image. The display control module 283 may load an image linked to the main image to output the loaded, linked image to the auxiliary window.

In the following description, the HMT device 100 according to various embodiments of the present disclosure is described below referring to FIGS. 3 to 7.

FIG. 3 illustrates a perspective view of an electronic device coupled to an HMT frame according to various embodiments of the present disclosure.

Referring to FIG. 3, the HMT device (e.g., the HMT device 100 shown in FIG. 1), according to an embodiment of the present disclosure, may be implemented in a form that is capable of coupling to an external device (or a mobile electronic device, such as a smartphone). For example, the HMT device 100 may be designed in such a way that an HMT frame 300 is detachably coupled with an external device (or a mobile electronic device).

The HMT frame 300 may include a main frame 310 and a wearable unit 320, coupled to the main frame 310, for fixing the main frame 310 to part of the user's body.

The main frame 310 may include a control device (or a user input module) 311 for controlling an external device and a connector 312 for communicating with the external device.

A control device (or a user input module) 311 may include at least one of physical keys, physical buttons, touch keys, a joystick, a wheel key 313, a touch pad, and the like. In an embodiment of the present disclosure, when the control device (or a user input module) 311 is implemented with a touch pad, the touch pad may be installed to the side of the main frame 310. The touch pad may include control objects (e.g., graphical user interface (GUI) for controlling audio or videos) representing functions of the HMT frame 300 or an external device.

The connector 312 may support communication between the HMT frame 300 and an external device. The connector 312 may be connected to an electrical coupling port (e.g., a USB port) of the external device, and may provide user input signals, created in the main frame 310, to the external device. For example, the HMT frame 300 may be connected to an external device by a USB interface to transfer touch inputs, received through the touch panel, to the external device. The external device may perform functions corresponding to the touch inputs created in the touch panel of the HMT frame 300. For example, the external device may adjust the volume or play back a video in response to the touch inputs.

According to an embodiment of the present disclosure, the main frame 310 may further include a display position adjustment part of which is exposed on the outside of the main frame 310.

The main frame 310 may be detachably coupled with the external device. For example, the main frame 310 may form a hollow spatial structure or cavity for receiving an external device. The hollow spatial structure of the main frame 310 may be made of an elastic material. The hollow spatial structure of the main frame 310 may be made of a flexible material so that the space varies in size according to various sizes of external devices, thereby receiving the external device.

The backside of the main frame 310 may include a face contacting unit which contacts the user's face and a part of which a lens assembly including at least one lens can be inserted into, facing the user's eyes. The lens assembly may be designed so that a display or transparent/translucent lenses are fixed to form a single body or detachably coupled to each other. The face contacting unit may include a nose recess shaped to receive a user's nose.

The main frame 310 may be made of a material that makes a user feel comfortable when the user wears the HMT frame 300 and supports an external device, e.g., a plastic. As another example, the main frame 310 may be made of at least one of glass, ceramic, metal (e.g., aluminum), and metal alloy (e.g., steel, stainless steel, titanium, magnesium alloy, and the like), in order to provide strength or a pleasing appearance.

The wearable unit 320 may be worn on a part of the user's body. The wearable unit 320 may be implemented with a band made of an elastic material. In other embodiments of the present disclosure, the wearable unit 320 may include eyeglass temples, helmets, straps, and the like.

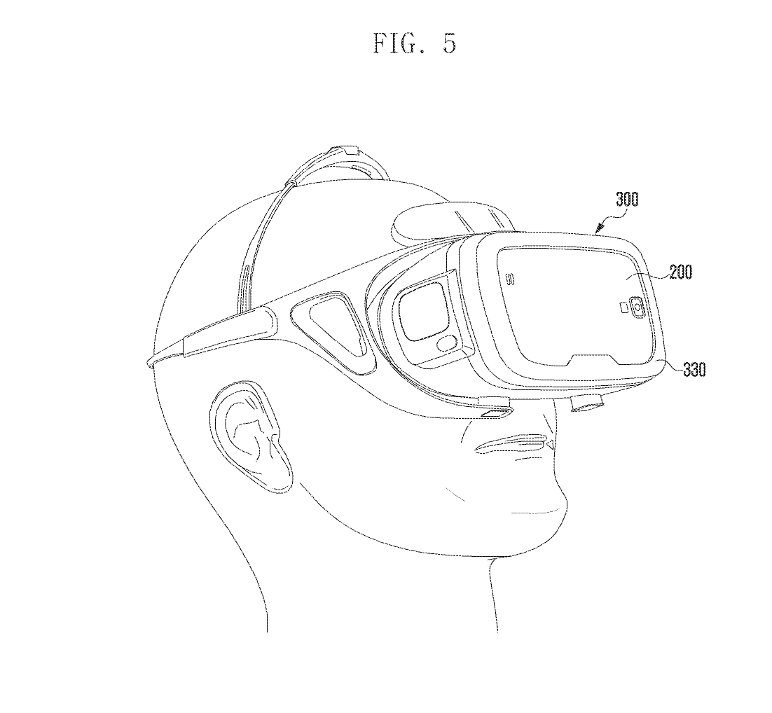

FIG. 4 illustrates an exploded perspective view of an HMT frame and an electronic device, which are coupled to each other, according to various embodiments of the present disclosure, and FIG. 5 illustrates an HMT device being worn on a head of a user according to various embodiments of the present disclosure.

Referring to FIG. 4, the HMT device 100 may allow an external device 200 to be coupled to the HMT frame 300 shown in FIG. 3. The HMT frame 300 may include a cover 330 for fixing the external device 200 which is coupled to the main frame 310. The cover 330 may be formed with a physical coupling part, such as a hook, a magnet, an electromagnet, and the like, to be coupled to the main frame 310. The cover 330 may prevent the external device 200 from being separated from the HMT frame 300 as the user's moves or protect the external device 200 against external impacts.

The HMT frame 300 and the display of the external device 200 may be coupled to face each other. The HMT device 100 may be assembled in such a way that the HMT frame 300 and the external device 200 are coupled to each other and the cover 330 is coupled to the HMT frame 300, covering the external device 200. As shown in FIG. 5, when the user wears the HMT device 100 on the head, he/she can watch the screen of the external device 200.

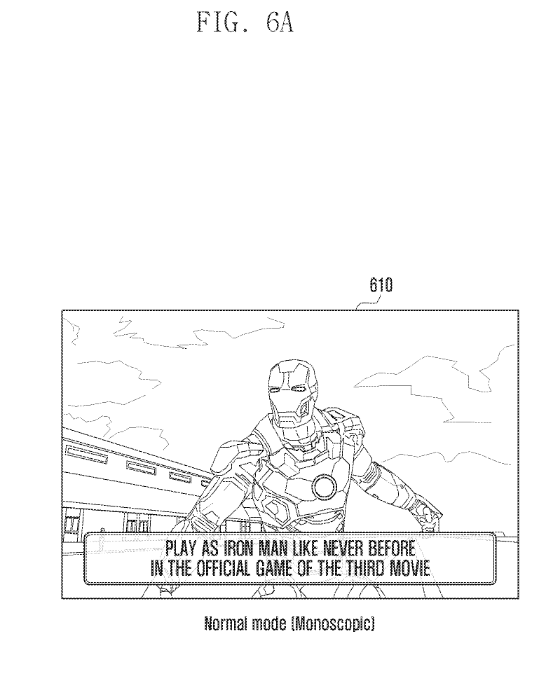

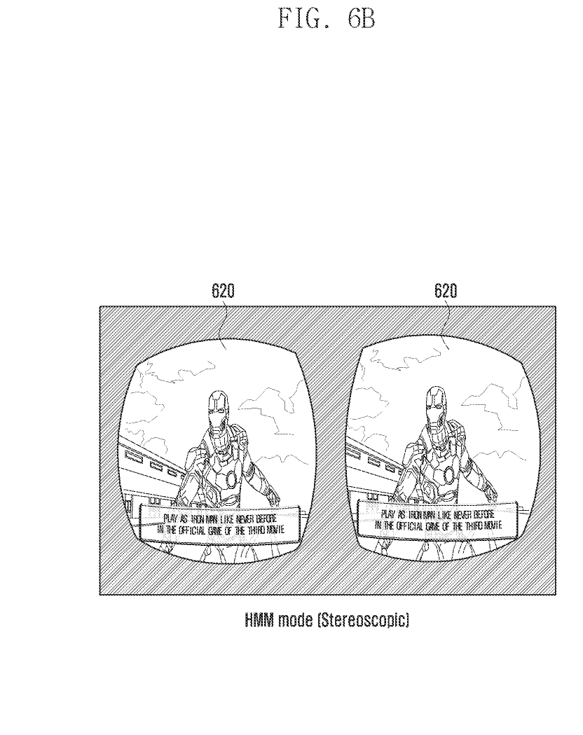

FIGS. 6A and 6B illustrate diagrams that describe an image display mode of an HMT device according to various embodiments of the present disclosure.

Referring to FIG. 6A, the HMT device may provide at least one of a normal mode, a head-mounted (HM) mode, a virtual reality (VR) mode, and the like.

The normal mode may be a mode where one of the spatial display data items is output as a main image 610 as shown in FIG. 6A.

The HM or VR mode may be a mode to provide a see-through function for providing augmented reality (AR) and/or a see-closed function for providing virtual reality (VR) through a display. For example, when an electronic device is installed to the main frame 310 of the HMT device, according to an embodiment of the present disclosure, and is running, the electronic device may switch the display mode from a normal mode to an HM or VR mode.

Referring to FIG. 6B, the HM or VR mode may be a mode to separate one image (or video) into two images (videos) 620 to output them so that the user can see them with two eyes. When the HMT device operates in HM or VR mode, the HMT device may process spatial display data to provide images to the user without distortions that may be caused by the characteristics of the HMT device. For example, since the lenses of the main frame 310 may cause a distortion on the image in HM or VR mode, the HMT device may process plane images with reverse distortion according to characteristics of the lenses, thereby providing non-distorted images to the user.

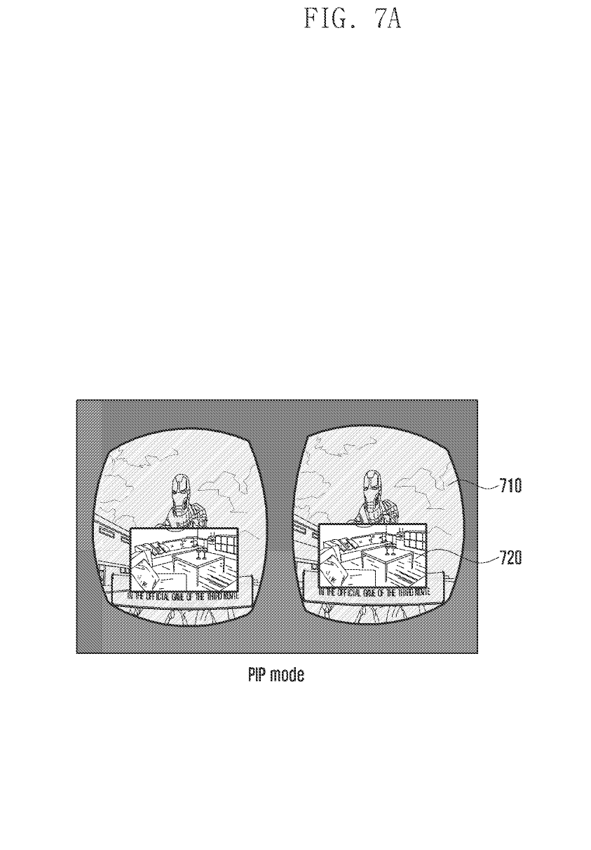

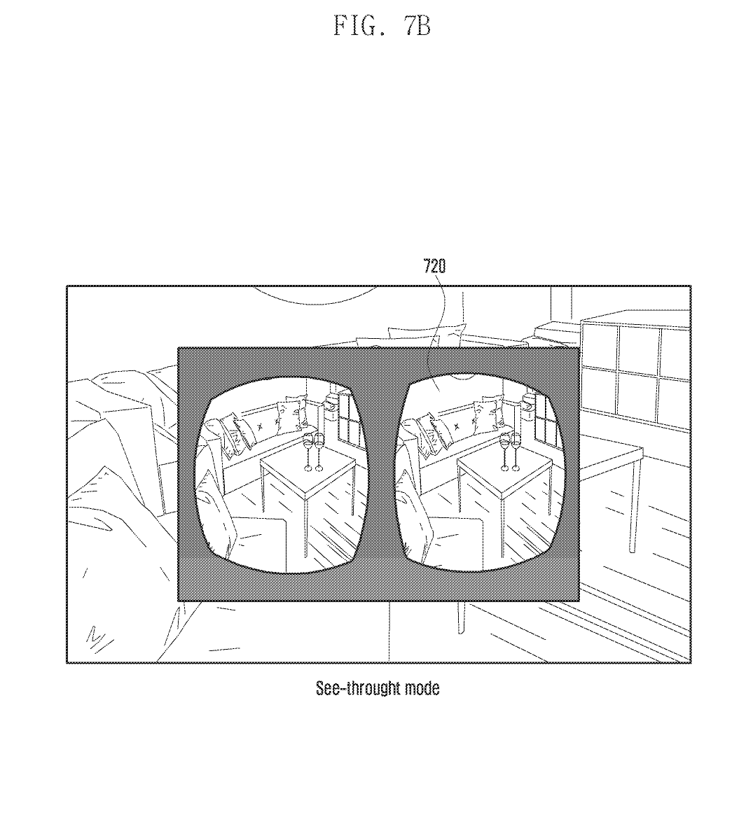

FIGS. 7A and 7B illustrate diagrams that describe an image display mode of an HMT device according to various embodiments of the present disclosure.

Referring to FIGS. 7A and 7B, the HMT device may provide a see-through mode using a camera. The HMT device may obtain preview images from a camera according to display modes and provide the image as videos.

According to an embodiment of the present disclosure, when the HMT device detects an input for switching the mode from a VR mode to a see-through mode, the HMT device may execute the camera (e.g., a rear camera of the external device or an internal camera of the HMT device).

The HMT device may show the preview screen 720 of the rear camera on a part of the VR screen 710 in PIP as shown in FIG. 7A. The HMT device may switch the VR screen to a background, and extend the preview screen 720 on the entire area as shown in FIG. 7B.

Therefore, the user can experience the outside virtual environment, and simultaneously determine the surrounding environment through the video from the camera if necessary.

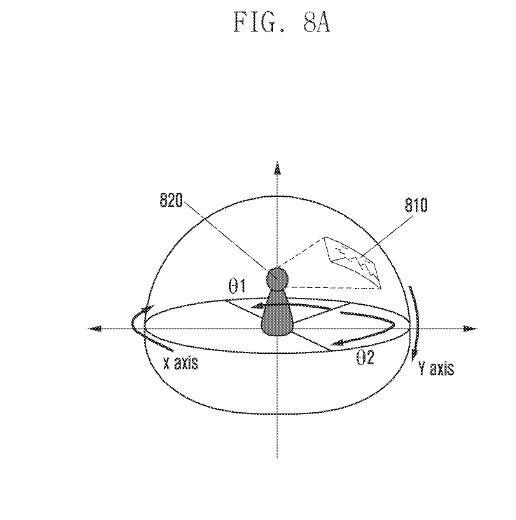

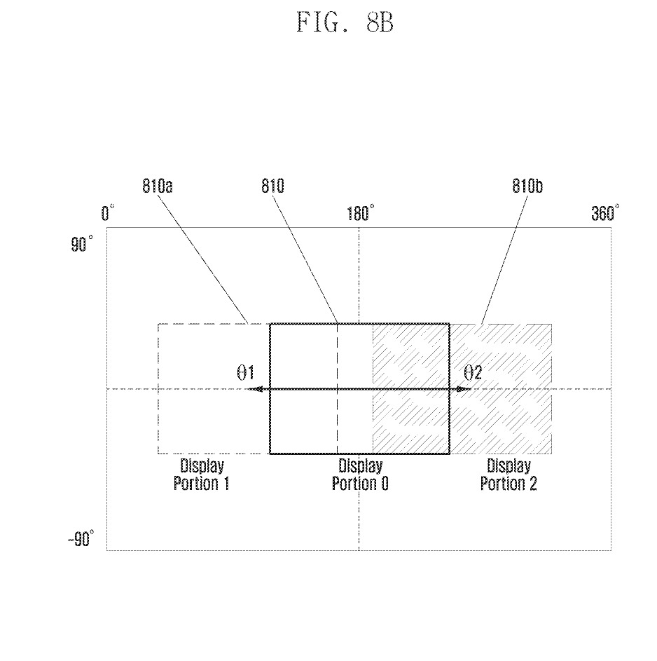

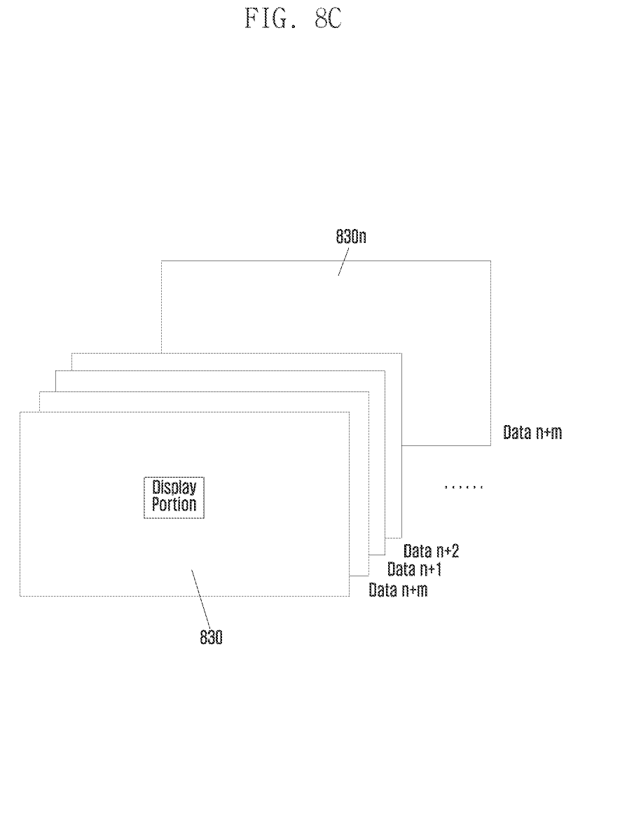

FIGS. 8A, 8B, and 8C illustrate diagrams that describe spatial display data provided by an HMT device according to various embodiments of the present disclosure.

Referring to FIGS. 8A, 8B, and 8C, the HMT device may provide spatial display data including information about coordinates to the user via the display. The spatial display data may include information about coordinates and/or sequence information. The spatial display data may refer to a set of display data created and stored as the coordinate information items and the sequence information items are associated with each other. The information about coordinates may include location coordinates representing locations where the user or the electronic device is located in the virtual or real space, vector coordinates, or spatial coordinates of two- or three-dimensions for a spatial image displayed via the electronic device. The spatial display data may be formed with data that have continuity in a particular and are related to each other. For example, the spatial display data may be data related to the change of distances, data related to the order of time, and data related to the change of places or locations. As spatial display data, an image displayed on the screen may be altered with respect to at least one of size, proportion, scale, resolution, and the like, according to the change of information related to coordinates.

As shown in FIGS. 8A and 8B, spatial display data (e.g., virtual spatial data) representing virtual space may include coordinates (e.g., x, y, z) and angles (e.g., 01 and 02). The HMT device may output part of the spatial display data to the main screen of the display. As shown in FIG. 8B, a block area 810 may be an area output to the display. The HMT device may process part of the virtual space data to be output to the main screen of the display. A user 820 wearing the HMT device may feel as if he/she is at a place within the virtual space.

The HMT device may alter data output to the main screen according to the control of inputs by the user 820. When the user 820 makes a request to move the screen to the left, the block area 810 may move to the direction varying by θ1 to output data of block area of portion 1 810a on the display. When the user 820 makes a request to move the screen to the right, the block area 810 may move to the direction varying by θ2 to output data of block area of portion 2 810b on the display. Since spatial display data has areas overlapping on the display, such as the block area 810, block area of portion 1 810a, and block area of portion 2 810b, a spatial image with continuity or direction property can be shown.

As another example, as shown in FIGS. 8A, 8B, and 8C, spatial display data with mobility to a particular direction, such as a street view, may include information about coordinates and sequence information. The HMT device may output image (Data n) 830-1 corresponding to a particular location to the display. The spatial display data may include data (Data n, Data n+1, Data n+2, Data n+3, . . . , Data n+m) including sequence information and information (e.g., coordinates information) bout the change of location that can be obtained from the movement in a certain direction from a particular location. When a request is made to alter images according to a user's control inputs, the HMT device may alter an image 830-1, output to the main screen, to image 830-2, 830-3 or 830-n according to the order of sequence information items or the order of items of information about coordinates according to the change of location, and may output the altered image.

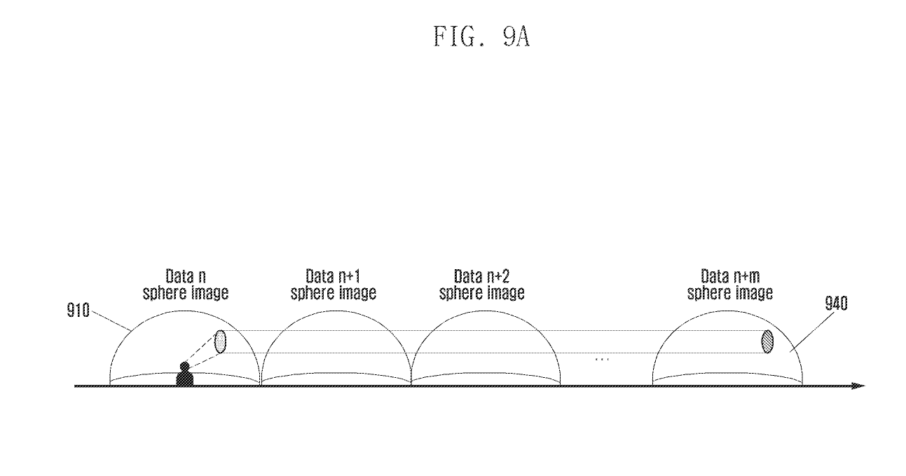

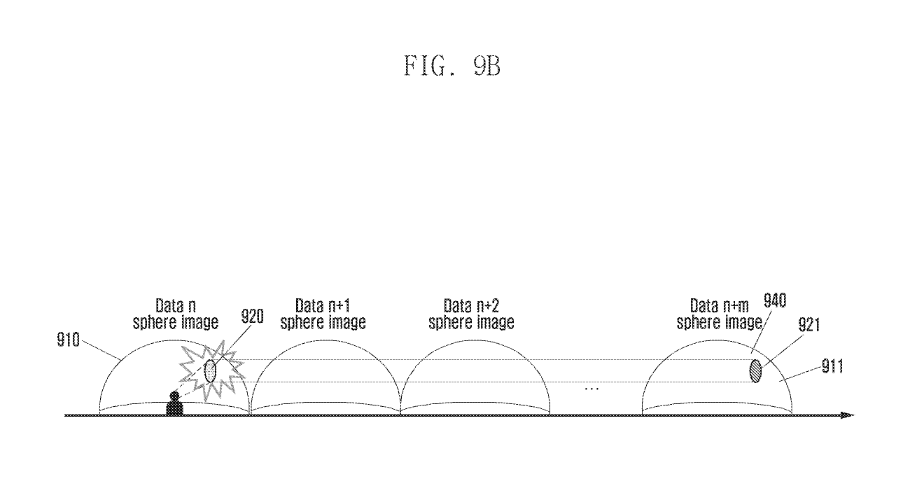

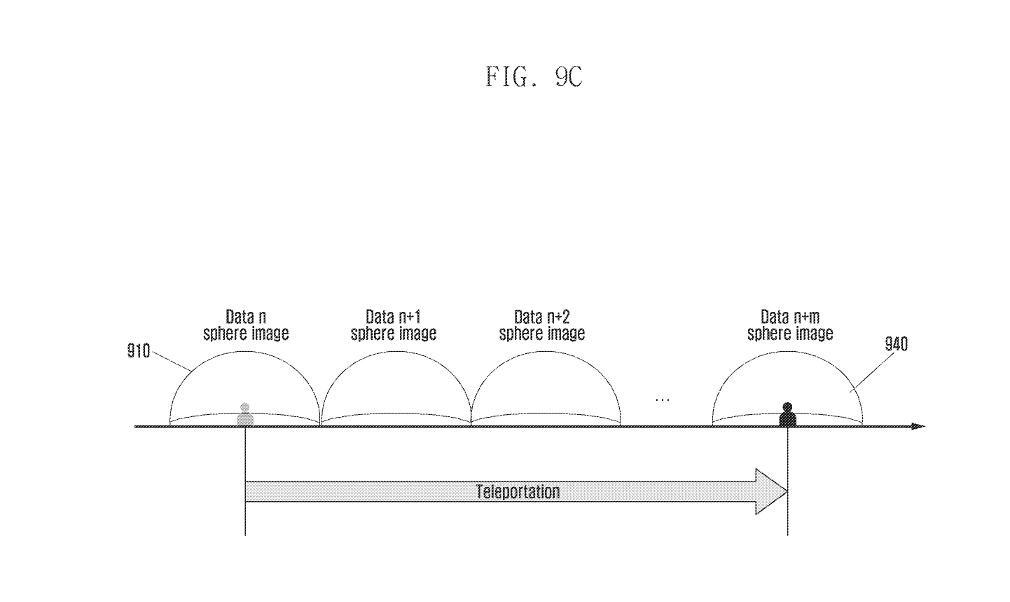

FIGS. 9A, 9B, and 9C illustrate diagrams that describe an alteration of viewpoints of a user wearing an HMT device according to various embodiments of the present disclosure.

Referring to FIGS. 9A, 9B, and 9C, the HMT device, according to an embodiment of the present disclosure, may output, to the display, one item of the spatial display data that has the mobility to a certain direction. The HMT device may output Data n, as a main image, in response to a user input. For example, when the HMT device displays a road map as shown in FIG. 9A, the user may perceive a first space 910.

The user wearing the HMT device may make a request to alter display data (e.g., a viewpoint altering input). The HMT device may output, as a main image, Data n+1 which has a direction property to a certain direction (e.g., a forward shift) from Data n in response to the viewpoint altering input. When the viewpoint altering input to the same direction is continuously entered, the HMT device may output data altered with direction property, Data n+2, . . . , Data n+m, to the main image sequentially. As images with direction property are altered, the user may feel as if he/she moves in a certain direction. For example, as the main image is altered, the user perceives the second space (Data n+2), third space (Data n+3), or m-th space (Data n+m) 940 so that he/she can ascertains that the space has been altered from a particular location to another location.

In addition to the experience that the user feels as if he/she moves in the forward direction, he/she may also feel as if his/her location changes opposite to the forward direction in a state where his/her viewpoint is fixed to the forward direction. For example, in a state where Data n is output as a main image, the user may continue entering a request for viewpoint alteration which is opposite to the forward direction. According to the viewpoint altering inputs, the HMT device may alter Data n−1, Data n−2, . . . , Data n−m and output them to the main image sequentially. In this case, the user may feel as if he/she moves backwards in a state where his/her viewpoint is fixed to the forward direction.

As shown FIG. 9B, the HMT device may output an auxiliary window for controlling the user viewpoint alteration to the main screen. The user may control the auxiliary window to rapidly switch between images displayed on the display.

For example, the HMT device may output Data n as a main image and an auxiliary window image 920. The user may make a request to magnify only the auxiliary window image 920. In this case, the HMT device may load part, corresponding to the auxiliary window, from Data n+1 of the images of Data n to be output as an auxiliary window image. When the user continues making a request to magnify the auxiliary window image 920, the HMT device may load corresponding part from Data n+2 to be output as the auxiliary window image 920 as if the auxiliary window image 920 is enlarged gradually, and may load corresponding parts from Data n+m to output them as auxiliary window images sequentially. As shown in FIG. 9B, for the m-th space 940, the display data of Data n may be output as a main image 911 and the display data of Data n+m may be output as an auxiliary window image 921.

In a state where an image of Data n+m is displayed on an auxiliary window, the HMT device may detect a user input for selecting the auxiliary window. In this case, as shown FIG. 9C, the HMT device may output the main image outputting display data of Data n as display data of Data n+m. For example, the user may feel that the viewpoint has been altered from the first space 910 to the m-th space 940 according to the alteration of display data and thus he/she has moved from the first space 910 to the fourth space 940.

In order for the user to move to a relatively farther place by using the HMT device, he/she needs to repeat the entering of touch inputs, gestures, and the like, a number of times. In this case, since an embodiment of the present disclosure allows the user to feel as if he/she moves to such a faraway place once (e.g., the first space 910 to the m-th space 940) (which is ‘teleportation’), the user efficiency of the HMT device can be increased.

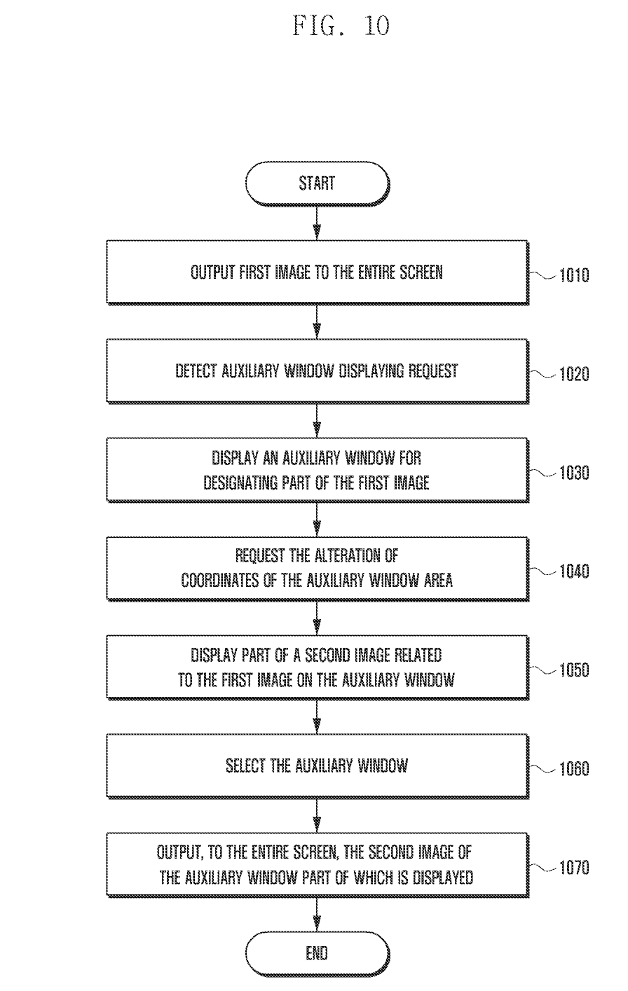

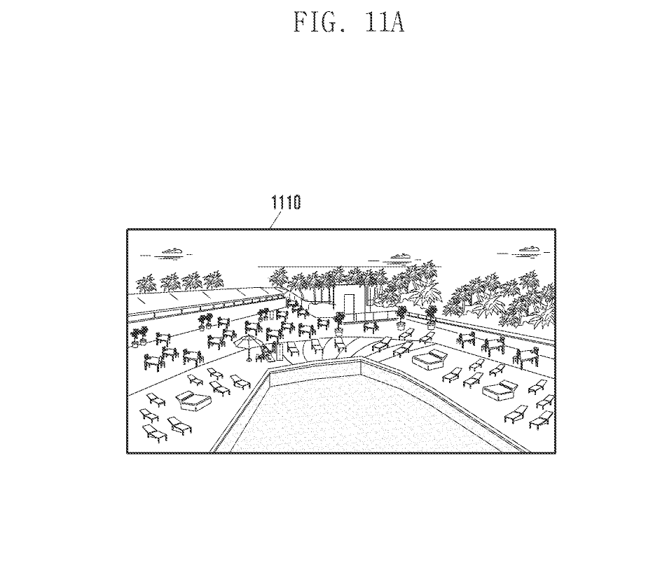

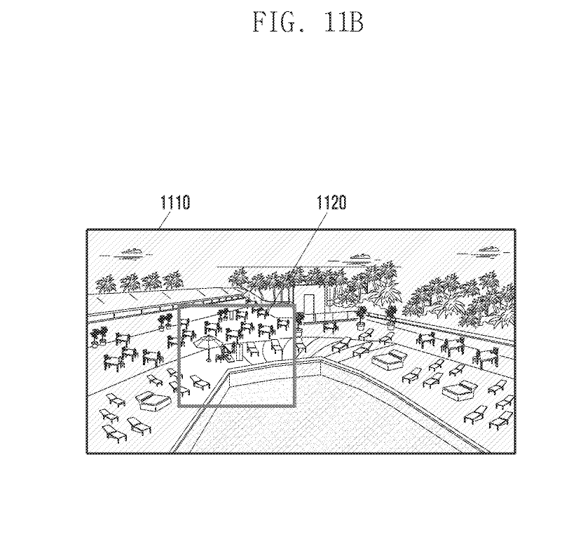

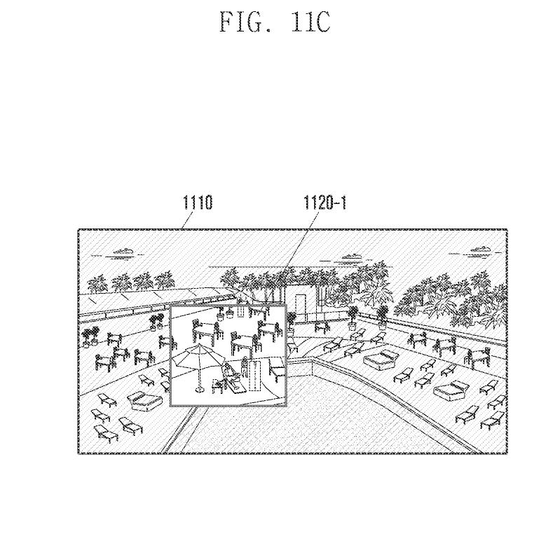

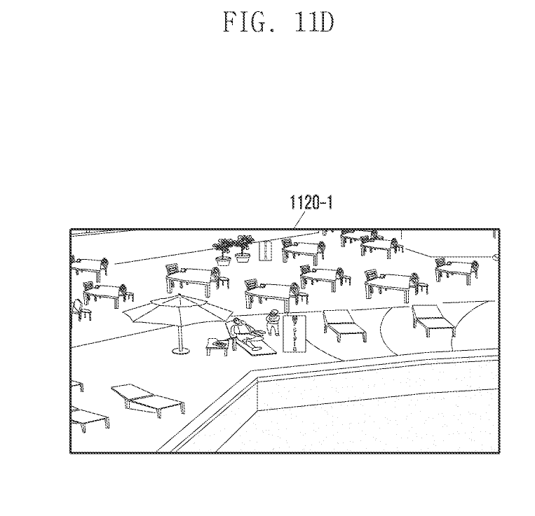

FIG. 10 illustrates a flow diagram that describes a method of controlling a display of images in an HMT device according to a first embodiment of the present disclosure, and FIGS. 11A, 11B, 11C, and 11D illustrates screens for controlling a display of images according to the first embodiment of the present disclosure.

Referring to FIGS. 10, 11A, 11B, 11C, and 11D, the HMT device may output a first image to the main screen corresponding to the size of the display module, under the user input control in operation 1010. The first image may be an image (or video) of a particular location or a particular place within a virtual space.

For example, as shown in FIG. 11A, the HMT device may output, to the display, a first image 1110 of a particular place, such as a street view (or road map). The first image 1110 may be one data item (e.g., Data n) of the spatial display data with mobility to a certain direction.

The HMT device may detect an input of an auxiliary window displaying request in operation 1020. The auxiliary window displaying request may be performed by at least one of a voice input, a touch input, a motion input, a brain wave input, a gesture input, a point of gaze input, a movement of the user's head, and the like.

The HMT device may display an auxiliary window to the first image in response to a request input in operation 1030. The auxiliary window may be a view frame for designating part of the image displayed on the main screen. The auxiliary window may share part of the image displayed on the main screen. The HMT device may display an auxiliary window at a particular position (e.g., the center) on the main screen according to the settings. The HMT device may provide a function for altering at least one of location, shape, size, and effect of the auxiliary window through a user's settings or option menus. The HMT device may alter the location of the auxiliary window according to an input request for controlling an auxiliary window.

The HMT device may display an auxiliary window 1120 sharing part of the first image 1110 on the first image 1110 as shown in FIG. 11B.

In an embodiment of the present disclosure, in order to inform the user that the auxiliary window 1120 is activated, the HMT device may display the auxiliary window 1120 on the main screen so that the area inside the auxiliary window 1120 is distinguished from the area outside the auxiliary window 1120, or the main screen. It should, however, be understood that the present disclosure is not limited to the distinctive displaying method. For example, the HMT device may shade or dim the main screen, except for the area of the auxiliary window. The HMT device may output, as a color image, a first image inside the area of the auxiliary window 1120 and, as a black-and-white image, a first image outside the area of the auxiliary window 1120.

The HMT device may detect a user input for requesting the alteration information about coordinates of the auxiliary window area in operation 1040. The user may control the auxiliary window to input a request for altering coordinates of the auxiliary window area (e.g., a request for increasing/decreasing the resolution, a request for moving the location, and the like). The alteration of coordinates may be an alteration of location coordinates of spatial display data, an alteration of the order of sequence, an alteration of spatial coordinates, and the like.

For example, the user may enter inputs to enlarge the image in the auxiliary window area. The HMT device may obtain second images (Data n+1, Data n+2 . . . Data n+m), related to a first image (Data n), according to an order of sequence in a certain direction, from a storage module or an external device.

The HMT device may detect spatial display data in response to a request for altering coordinates of an auxiliary window, and may output, to the auxiliary window, part of a second image of which the coordinates are altered, related to the first image, in operation 1050. The HMT device may detect information about the auxiliary window displayed on the first image. The HMT device may detect the display location and size of the auxiliary window, and an area overlapping the display location of the auxiliary window in the second image according to the order of sequence in a certain direction.

For example, when the user makes a request to enlarge an image in the auxiliary window, the HMT device may display part of the second image1120-1, extracted from Data n+3, can be displayed on the auxiliary window area displayed on the first image (Data n) 1110 as shown in FIG. 11C. The HMT device may display part of the second image 1120-1 extracted from Data n+3 on the auxiliary window area, and maintain the display of the first image (Data n) 1110 on the main screen except for the auxiliary window. For example, when the first image 1110 is a photograph taken at a particular place, the second image 1120-1 extracted from Data n+3 may be a photograph taken from a location separated by a certain distance from the first image 1110. The HMT device loads the second image 1120-1 extracted from Data n+3 to output the second image 1120-1 to the auxiliary window area, thereby providing an effect to the second image 1120-1 displayed on the auxiliary window as if part of the first image is enlarged.

As another example, the user may make a request to reduce an image in the auxiliary window. The HMT device may load second images (Data n−1, Data n−2, . . . , Data n−m) according to the order of sequence with mobility to another direction and output them to the auxiliary window area displayed on the first image.

The HMT device may detect a user input for selecting the auxiliary window in a state where an image of which the coordinates are altered is displayed in operation 1060.

The HMT device may display, on the entire screen, the second image of the auxiliary window part of which is displayed, in response to the input for selecting the auxiliary window, in operation 1070. As shown in FIG. 11D, when part of the second image1120-1, designated as Data n+3, is output to the auxiliary window area, the HMT device may alter the second image 1120-1 designated as Data n+3 to be displayed on the entire screen in response to the input for selecting the auxiliary window.

For example, in order for the user to move spatial display data with mobility to a relatively faraway place, he/she needs to repeat the entering of inputs for altering the spatial image. In this case, the embodiment of the present disclosure may control the input of the auxiliary window to move to such a faraway place once, thereby increasing the use convenience of the HMT device.

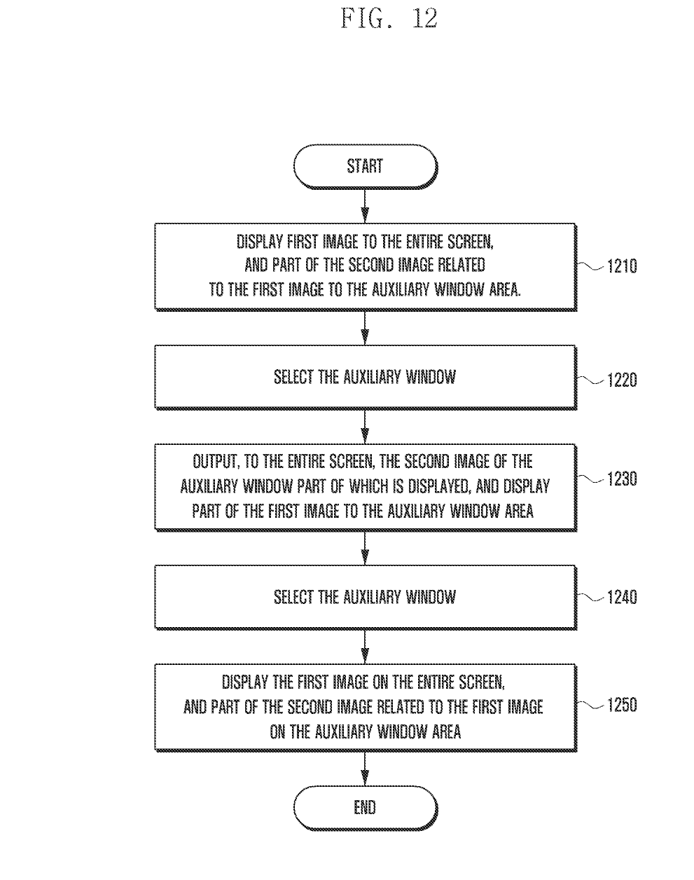

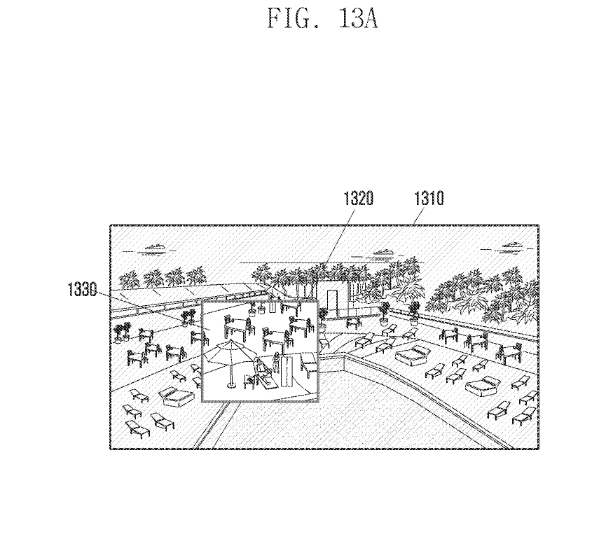

FIG. 12 illustrates a flow diagram that describes a method of controlling a display of images in an HMT device according to a second embodiment of the present disclosure, and FIGS. 13A, 13B, and 13C illustrate screens for controlling a display of images according to the second embodiment.

Referring to FIGS. 12, 13A, 13B, and 13C, the HMT device may output a first image to the main screen, and a part of a second image, the coordinates of which are altered, associated with the first image, to the auxiliary window in operation 1210. For example, the HMT device may display part of the second image extracted from Data n+3 on the auxiliary window area, and maintain display of the first image (Data n) on the main screen except for the auxiliary window.

For example, as shown in FIG. 13A, the HMT device may output part of the second image 1330 extracted from as Data n+3 to the area of an auxiliary window 1320 displayed on a first image (Data n) 1310. The user may feel an effect, through the area of the auxiliary window 1320 of the first image 1310, as if part of the first image 1310 is enlarged.

The HMT device may detect a user input for selecting the auxiliary window in operation 1220. The HMT device may switch the second image of which the part is displayed on the auxiliary window to the entire screen in response to the selection input of the auxiliary window, and may output part of the first image to the auxiliary window area, in operation 1230.

As shown in FIG. 13B, the HMT device may output, to the entire screen 1330-1, the second image extracted from Data n+3 in the first image, and to the auxiliary window area, part 1310-1 of the first image (Data n) in the second image. In this case, the user may control the auxiliary window to feel as if he/she moves from a place where the first image is stored to a place where the second image is stored.

In a state where the entire screen and the image of the auxiliary window are switched, the HMT device may detect a user input for selecting the auxiliary window in operation 1240. The HMT device may re-display the first image 1310 on the entire screen, and a part of the second image 1330 related to the first image 1310 on the auxiliary window area, in response to the user input for selecting the auxiliary window, in operation 1250.

As shown in FIG. 13C, the HMT device may re-switch between the entire screen and the image of the auxiliary window to output them. In this case, the user may feel as if he/she moves to a place where the second image 1330 is stored and returns to a place where the first image 1310 is stored.

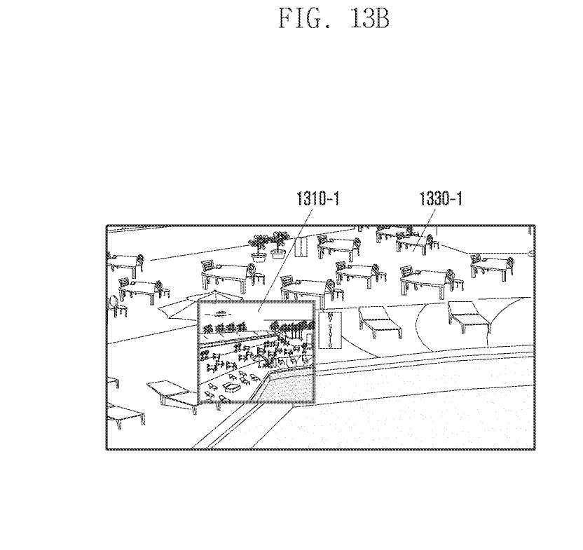

FIGS. 14A and 14B illustrate diagrams that describe a method of controlling a display of images in multi-directions according to various embodiments of the present disclosure.

Referring to FIGS. 14A and 14B, the HMT device according to various embodiments of the present disclosure may provide a function for controlling the display of images in multi-directions by using spatial display data. For example, as shown in FIG. 14A, the HMT device may provide an image of Data n to a user 1410 through the display. The user 1410 may be in a state where he/she perceives a particular place corresponding to Data n.

When the user inputs an auxiliary window displaying request, the HMT device may output, to a main screen 1420, a plurality of auxiliary windows 1430, 1431, 1432, and 1433 corresponding to in a plurality of directions as shown in FIG. 14B. The number of directions may be two or more.

For example, the HMT device may output the forward auxiliary window 1433, the rear auxiliary window 1432, the left auxiliary window 1431 and the right auxiliary window 1430 with respect to the user, as well as the direction that the user sees, and may also output images for the respective auxiliary windows. When the image that the user sees is an image extracted from Data n, the spatial display data may have data of the forward direction (e.g., North) that are Data n+1, Data n+2, and the like, data of the rear direction (e.g., South) that are Data n−1, Data n−2, and the like, data of the right direction (e.g., East) that are Data n+1′, Data n+2′, and the like, and data of the left direction (e.g., West) that are Data n−1′, Data n−2′, and the like.

The HMT device may display two or more auxiliary windows, and also output information for notifying the display of the directions for the respective auxiliary windows. For example, when a user is at a place from which he/she can move in a number of directions, e.g., an intersection, the HMT device may output images for the front/rear direction and the left/right direction to the auxiliary windows. The user may control the auxiliary windows output to the display, so that he/she can feel as if he/she displays an image corresponding to a location to which he/she wants to move, returns to the original place or moves in another direction.

FIG. 15 illustrates a flow diagram that describes a method of controlling a display of images in an HMT device according to a third embodiment of the present disclosure, and FIGS. 16A, 16B, 16C, and 16D illustrate screens for controlling a display of images according to the third embodiment of the present disclosure.

Referring to FIGS. 15, 16A, and 16B, the HMT device may output an image as the whole screen to the display in operation 1510. The image may be part of the spatial display data but is not limited thereto. For example, the image may be an image of a particular location or a video.

The HMT device may determine whether the image output to the display has link information in operation 1520. The link information may be information about images stored without the relation to sequence information and information about the change in locations (e.g., coordinates information) that can be obtained from the movement in a certain direction, from among spatial display data.

For example, spatial display data with movement direction, such as a street view, may be information about images stored according to movement. However, spatial display data may not include images of chief tourist attractions or noted places that it is difficult to access or to obtain 3D spatial images (e.g., the direction of the sky). In order to display an image of a particular place that it is difficult to access or to obtain, the link information may be directory information or address information about the image additionally set to spatial display data. The link information may be stored and associated with an image output to the main screen of the display. When the image output to the display has link information in operation 1520, the HMT device may detect a location to display the link information from the image in operation 1530. The HMT device may display a link information notifying object on a display location detected from the image in operation 1540. The HMT device may notify the user that a notification object has been displayed, in various forms, such as a display of a pointer, output of a sound, an effect of vibration, and the like. For example, as shown in FIG. 16A, when the image includes link information stored, associated with spatial display data, the HMT device may display a notification object 1620 for notifying that an image 1610 output to the display has link information.

The HMT device may detect a user input for selecting a notification object in operation 1550. The HMT device may also detect a user input for requesting the display of an auxiliary window. The HMT device may output, to the auxiliary window, an image corresponding to the link information on the image, in response to the user input, in operation 1560. The HMT device may load an image set to the link information to output the loaded image to the auxiliary window in a PIP mode. The image set to the link information may be an image that is stored in the memory or received from a server through the address.

For example, as shown in FIG. 16B, the HMT device may output, to an auxiliary window 1630, a link information image 1640 that is stored and associated with an object output onto the image 1610 output to the display. The link information image 1640 may be a part of an image, enlarged and stored without information about coordinates.

In a state where a user wearing the HMT device is experiencing an effect as if he/she moves to a particular place, when he/she has difficulty in accessing a place, such as a tourist attraction or a noted place or in obtaining a proximity image, such as an image of 3D space (e.g., the direction of the sky), the HMT device may load an image set to link information to provide the loaded image to the display. The user wearing the HMT device may feel as if he/she directly visits the main tourist attraction or noted place in the real world.

According to another embodiment of the present disclosure, the HMT device may also provide virtual images as link information. For example, as shown in FIG. 16C, the HMT device may display, on the display, part of the image 1640, from among spatial display data corresponding to virtual space, e.g., a virtual gallery, a virtual museum, and the like. In this case, the HMT device may provide, as link information, a virtual image (e.g., an enlarged image corresponding to a virtual image) of particular spatial coordinates). In general, in order for a user to experience virtual space, he/she needs to move to a particular location through virtual space with the user's viewpoint. For example, the user controls a movement controller 1660 to continue to move or shift in the forward direction, which causes user inconvenience.

Since the HMT device provides virtual images as link information, although the user does not move in virtual space by controlling the movement controller 1660, the HMT device may load images of particular orientation coordinates to output the images to the display. As shown in FIG. 16D, when the user selects a notification object 1650, the HMT device may load an enlarged image 1651 stored corresponding to the notification object 1650 and may output the image 1651 to the auxiliary window.

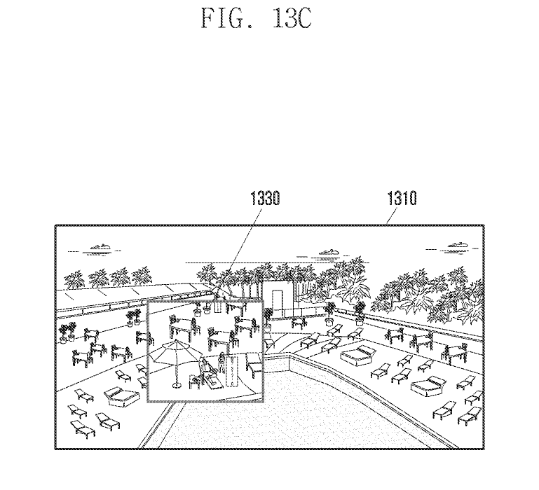

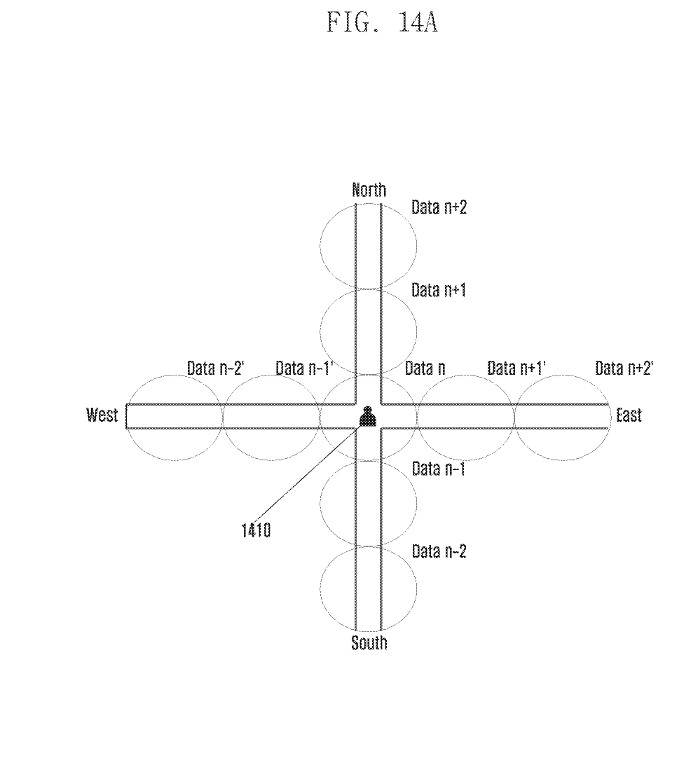

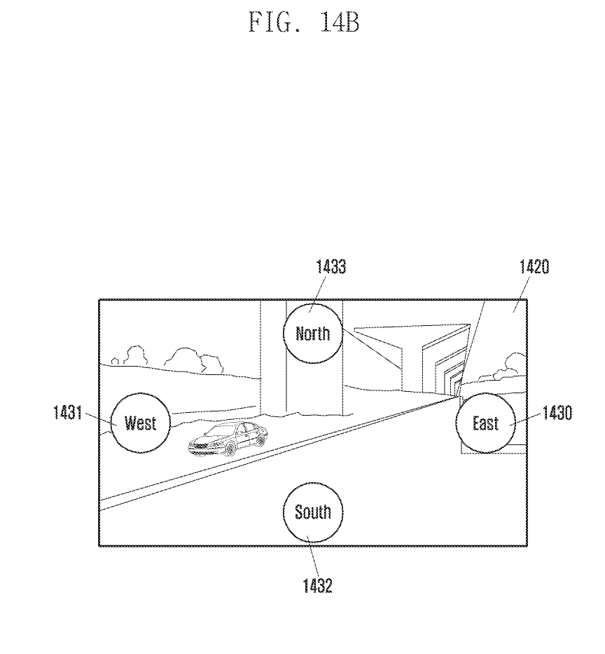

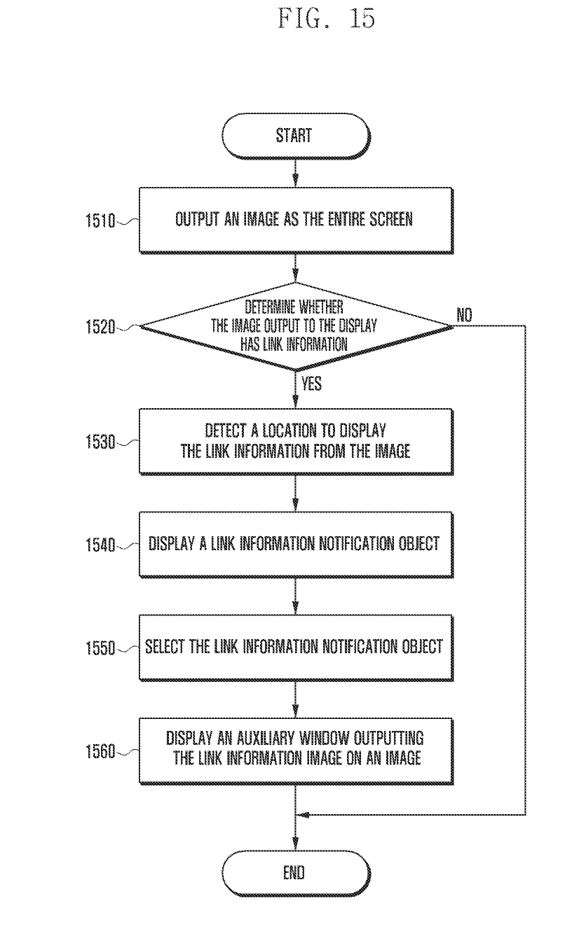

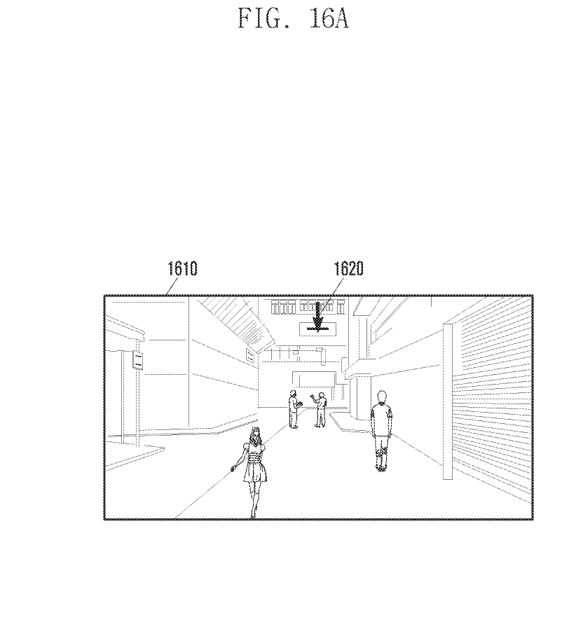

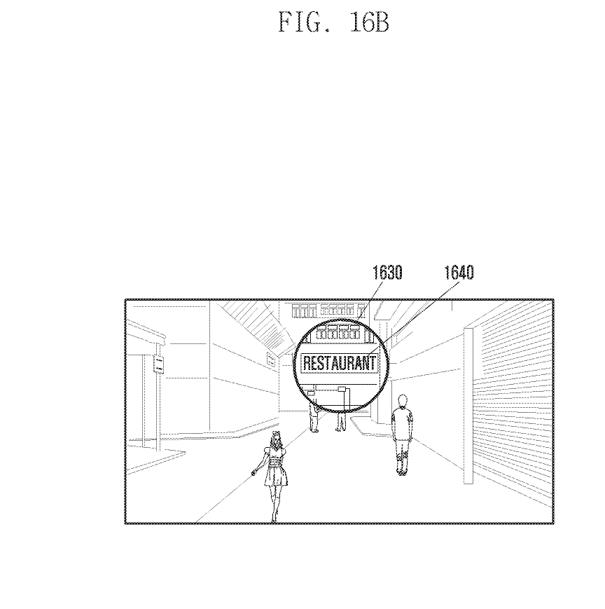

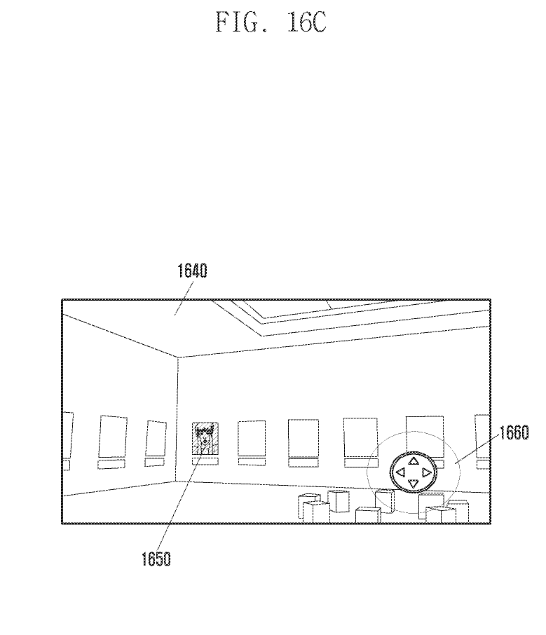

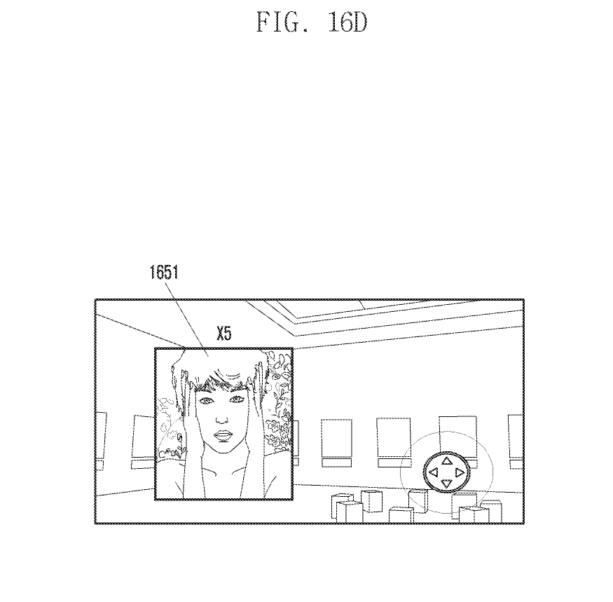

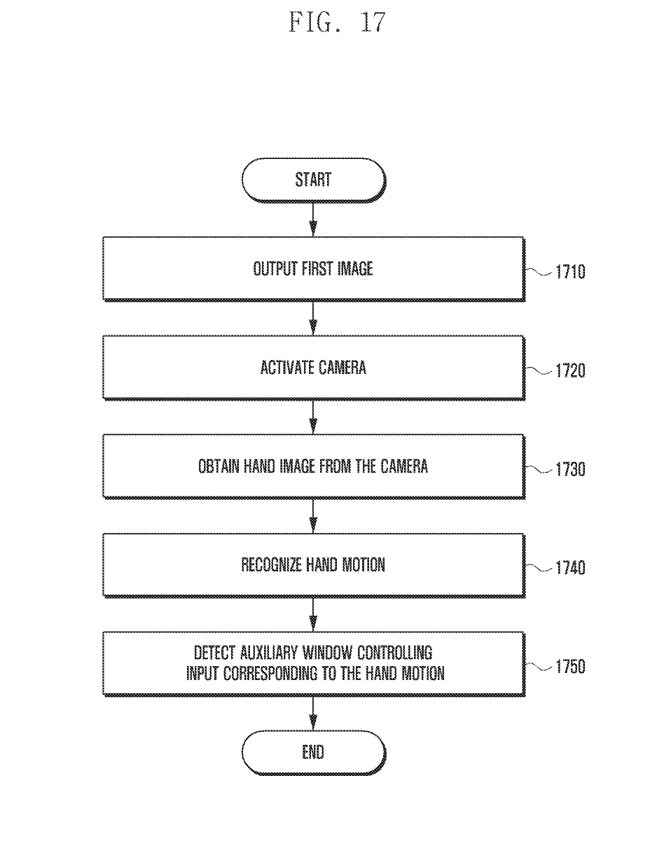

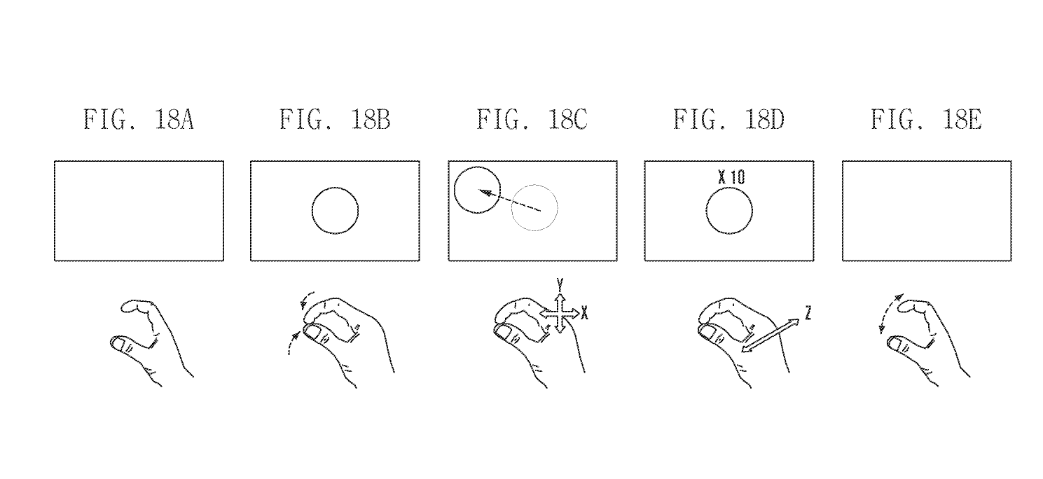

FIG. 17 illustrates a flow diagram that describes a method of inputting image control inputs according to various embodiments of the present disclosure, and FIGS. 18A, 18B, 18C, 18D, and 18E illustrate diagrams of user inputs for controlling a display of images according to various embodiments of the present disclosure.

Referring to FIGS. 17, 18A, 18B, 18C, 18D, and 18E, the HMT device may support a function for controlling an auxiliary window through hand motion or gesture inputs.

The HMT device may output images to the display in operation 1710. The HMT device may activate a camera module to detect hand motion or gesture inputs in operation 1720. The HMT device may obtain hand images from the camera in operation 1730.

Referring to FIG. 18A, the HMT device may output a first image as the entire screen to the display. The user wearing the HMT device may make a hand gesture so that the activated camera can recognize the hand gesture in order to display an auxiliary window on the display.

In a state where the user is wearing the HMT device, he/she may make a hand motion or gesture by using his/her hand.

The HMT device may recognize the hand motion through the hand image obtained from the camera in operation 1740. For example, the HMT device may separate the area of the hand, except for the background, from the video obtained through the activated camera, by using the color information. The HMT device may extract characteristic points from the area of the hand to recognize the motion and shape of the hand by the characteristic points. The HMT device may perform a pattern-matching operation, based on the motion and shape of the hand, to detect a hand motion or gesture.

The HMT device may execute an auxiliary window controlling command corresponding to the hand motion or gesture input in operation 1750.

Referring to FIG. 18B, the HMT device may output an auxiliary window to the main screen, in response to the user's particular hand motion (e.g., a motion for creating a circle like the letter ‘o’ by the thumb and the index finger contacting their tips with each other from the separate state) detected through the activated camera. The auxiliary window displaying request may also be implemented in various hand motions, e.g., a motion for creating a circle like the letter ‘o’ by the middle finger and the thumb contacting their tips, a motion for creating a circle like the letter ‘o’ by the two arms contacting the hands each other over the head from the separate state, and the like.

Referring to FIG. 18C, in a state where an auxiliary window is displayed, the HMT device may also move the location of the auxiliary window in response to the hand moving in a first direction (e.g., to the left/right direction, or X/Y axis).

Referring to FIG. 18D, in a state where an auxiliary window is displayed, the HMT device may alter information about coordinates of an image (e.g., the scale adjustment) displayed on the auxiliary window in response to the hand moving in a second direction (e.g., to the front/back direction, or Z axis).

Referring to FIG. 18E, the HMT device may remove the auxiliary window from the main screen in response to a particular hand motion of the user (e.g., a motion for creating the letter ‘C’ by the thumb and the index finger separating their tips each other from the contact state).

The HMT device, according to another embodiment of the present disclosure, may support a function for allowing a user wearing the HMT device to control the auxiliary window by the motion of the head. For example, the HMT device worn on the user's head may detect a particular motion of the head (e.g., nodding up and down or shaking both sides) to execute an auxiliary window or to alter the location to display the auxiliary window. In addition, when the user wearing the HMT device makes a motion to incline the head forward, the HMT device may alter information about coordinates of an image displayed on the auxiliary window to display the image in a first direction (e.g., a direction for enlargement). When the user wearing the HMT device makes a motion to bend the head backward, the HMT device may alter information about coordinates of an image displayed on the auxiliary window to display the image in a second direction (e.g., a direction for reduction).

The HMT device may also support a function for controlling the auxiliary window by voice inputs or key inputs, but not limited thereto. The HMT device may control the auxiliary window by various inputs.

The method of controlling a display of images and the electronic device adapted to the method according to various embodiments of the present disclosure, provide an auxiliary window to a main screen displayed on the display so that the auxiliary window shares part of the main screen, and output, to the auxiliary window, an image the scale of which differs from that of the image displayed on the main screen, or easily control the display of the image on the main screen, such as switching between images, altering between images, recovering the original image, and the like, thereby providing various user experiences.

Certain aspects of the present disclosure can also be embodied as computer readable code on a non-transitory computer readable recording medium. A non-transitory computer readable recording medium is any data storage device that can store data which can be thereafter read by a computer system. Examples of the non-transitory computer readable recording medium include a Read-Only Memory (ROM), a Random-Access Memory (RAM), Compact Disc-ROMs (CD-ROMs), magnetic tapes, floppy disks, and optical data storage devices. The non-transitory computer readable recording medium can also be distributed over network coupled computer systems so that the computer readable code is stored and executed in a distributed fashion. In addition, functional programs, code, and code segments for accomplishing the present disclosure can be easily construed by programmers skilled in the art to which the present disclosure pertains.

At this point it should be noted that the various embodiments of the present disclosure as described above typically involve the processing of input data and the generation of output data to some extent. This input data processing and output data generation may be implemented in hardware or software in combination with hardware. For example, specific electronic components may be employed in a mobile device or similar or related circuitry for implementing the functions associated with the various embodiments of the present disclosure as described above. Alternatively, one or more processors operating in accordance with stored instructions may implement the functions associated with the various embodiments of the present disclosure as described above. If such is the case, it is within the scope of the present disclosure that such instructions may be stored on one or more non-transitory processor readable mediums. Examples of the processor readable mediums include a ROM, a RAM, CD-ROMs, magnetic tapes, floppy disks, and optical data storage devices. The processor readable mediums can also be distributed over network coupled computer systems so that the instructions are stored and executed in a distributed fashion. In addition, functional computer programs, instructions, and instruction segments for accomplishing the present disclosure can be easily construed by programmers skilled in the art to which the present disclosure pertains.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. An electronic device comprising:
a display configured to display images;
an input unit configured to detect an image display control input; and
a controller configured to:
output a first image to the display, and
control an auxiliary window to be displayed on a part of the first image,
wherein the auxiliary window outputs a second image that has information about coordinates that differ from those of the first image.

2. The electronic device of claim 1,
wherein the information about coordinates comprises at least one of location coordinates and spatial coordinates; and
wherein the second image differs from the first image in at least one of size, proportion, scale, and resolution.

3. The electronic device of claim 1, wherein the controller is further configured to enlarge or reduce the part of the first image to output the enlarged or reduced image as the second image.

4. The electronic device of claim 1, wherein the controller is further configured to:
detect an input for selecting the auxiliary window, and
output the second image to an entire screen of the display in response to the input for selecting the auxiliary window.

5. The electronic device of claim 1, wherein the controller is further configured to output images in areas inside and outside the auxiliary window which are, in display form, distinguished from each other.

6. The electronic device of claim 1, wherein the controller is further configured to:
detect an input for selecting the auxiliary window, and
output the second image to an entire screen of the display and the part of the first image to the auxiliary window in response to the input for selecting the auxiliary window.

7. The electronic device of claim 1, wherein, when data with a plurality of directions related to the first image exists, the controller is further configured to output a plurality of auxiliary windows corresponding to the plurality of directions.

8. The electronic device of claim 1, wherein, when link information related to the first image exists, the controller is further configured to:
output a notification object indicating a presence of the link information to the first image, and
output the link information image as the second image in response to an input for selecting the notification object.

9. The electronic device of claim 1, wherein the controller is further configured to change at least one of the first image or the second image to be displayed on the display according to at least one of a movement of a user's head wearing the device, a user's point of gaze, a touch input, a voice input, a motion input, and a key input.

10. The electronic device of claim 1,
wherein the controller is further configured to control an auxiliary window to be displayed on a part of the first image, and
wherein the auxiliary window outputs a second image corresponding to a sequence information associated with the coordinates.

11. A method of controlling a display of images in an electronic device, the method comprising:
outputting a first image; and
displaying an auxiliary window on a part of the first image in response to an auxiliary window request input, wherein the auxiliary window outputs a second image that has information about coordinates that differ from those of the first image.

12. The method of claim 11,
wherein the information about coordinates comprises at least one of location coordinates and spatial coordinates; and
wherein the second image differs from the first image in at least one of size, proportion, scale, and resolution.

13. The method of claim 11, wherein the displaying of the auxiliary window comprises:
enlarging or reducing the part of the first image and outputting the enlarged or reduced image as the second image.

14. The method of claim 11, wherein the displaying of the auxiliary window comprises:
detecting an input for selecting the auxiliary window; and
outputting the second image to an entire screen of the display in response to the input for selecting the auxiliary window.

15. The method of claim 11, wherein the displaying of the auxiliary window comprises:
outputting images in areas inside and outside the auxiliary window which are, in display form, distinguished from each other.

16. The method of claim 11, wherein the displaying of the auxiliary window comprises:
detecting an input for selecting the auxiliary window;
outputting the second image to an entire screen of the display and the part of the first image to the auxiliary window, in response to the input for selecting the auxiliary window; and
displaying a part of the second image on the auxiliary window and outputting the first image to the entire screen of the display, in response to an input for making a request to switch between the first image and the second image.

17. The method of claim 11, wherein the displaying of the auxiliary window comprises:
outputting, when data with a plurality of directions related to the first image exists, a plurality of auxiliary windows corresponding to the plurality of directions.

18. The method of claim 11, wherein the displaying of the auxiliary window comprises:
outputting, when link information related to the first image exists, a notification object indicating a presence of the link information to the first image;
detecting an input for selecting the notification object; and
outputting the link information image as the second image in response to the input for selecting the notification object.

19. The method of claim 11, further comprising:
changing at least one of the first image or the second image to be displayed on the display according to at least one of a movement of a user's head wearing the device, a user's point of gaze, a touch input, a voice input, a motion input, and a key input.

20. At least one non-transitory computer readable storage medium for storing a computer program of instructions configured to be readable by at least one processor for instructing the at least one processor to execute a computer process for performing the method of claim 11.
